(19) United States
(12) Patent Application Publication
(10) Pub. No.: US 2018/0140384 A1
(43) Pub. Date: May 24, 2018

(54) ORTHODONTIC DEVICE

(71) Applicant: Sang Kohn CHANG, Daegu (KR)

(72) Inventor: Sang Kohn CHANG, Daegu (KR)

(21) Appl. No.: 15/572,122

(22) PCT Filed: Apr. 29, 2016
(86) PCT No.: PCT/KR2016/004514

§ 371 Date: Nov. 6, 2017

(30) Foreign Application Priority Data
May 6, 2015 (KR) 10-2015-0062858

(51) Int. Cl. A61C 7/20

(52) U.S. Cl. CPC A61C 7/20; A61C 7/146

(57) ABSTRACT

The present invention relates to an orthodontic device including: a unit wire positioned on a labial or lingual side of a tooth to be corrected of an upper teeth group or a lower teeth group; an adhesive adhered to the corresponding tooth while covering the unit wire, and fixed by curing; a soluble substance formed at the unit wire to prevent the unit wire from being adhered to the adhesive and dissolved afterwards; and an arch wire inserted into the adhesive from which the unit wire containing the soluble substance in a dissolved state has been removed and moving in an axial direction to move the entire teeth. Unlike the prior art, according to the present invention, a unit wire with a soluble substance applied thereto or a soluble substance covered by an adhesive at a circumferential surface thereof is attached to each of a plurality of teeth to be corrected, and then an arch wire is inserted via a space of the adhesive, formed as the soluble substance is dissolved. Thus, aesthetically pleasing appearance may be achieved due to the adhesive compared to existing brackets, inconvenience of individuals undergoing orthodontic treatment may be reduced due to decreased size of the orthodontic device, and the occurrence of cavities may be prevented.

### TECHNICAL FIELD

The present invention relates to an orthodontic device, and more particularly, to an orthodontic device that is fabricated by preparing a thin circular cylindrical form in a solidified state at room temperature using a substance capable of being dissolved by saliva secreted in the mouth or food, beverage, and the like to correspond to an exterior size of each of a plurality of teeth, wherein the cylindrical-type solidified product is adhered to each tooth to be corrected, using a resin, which is a tooth surface adhesive, to correspond to each tooth surface, and then dissolved after a certain period of time to form an empty space therein, i.e., a resin mini-tube form, through which an arch wire can be easily inserted, that significantly reduces the occurrence of cavities by using the resin, and that reduces orthodontic treatment costs.

### BACKGROUND ART

Generally, for a person, color and type of teeth are important factors in personal appearance, and teeth arrangement affects teeth themselves as well as a skull structure, and thus teeth are an important factor in personal appearance.

In particular, in the case of individuals with abnormal teeth arrangement, the teeth arrangement not only affects appearance, but also causes inconvenience in eating, and the like, and thus tooth correction is regarded as important dental treatment. For this reason, among dental treatments, orthodontic treatment has a long history, and methods thereof or technologies therefor have also been remarkably developed.

As a form of the orthodontic treatment having been widely used, there is a method in which a bracket is attached to an outer tooth surface of each of a plurality of teeth forming teeth arrangement, fixed structures formed in the respective brackets are bound together via a steel wire, i.e., a wire made of a strong material for forming an orthodontic arc line, and the position or direction of each tooth is gradually corrected by external physical force of the wire for a long period of time.

In addition, recently, there has been an increasing tendency to use a procedure in which a bracket is attached to an inside of each of a plurality of teeth, i.e., a surface of each tooth on the tongue side in the mouth, and the brackets are connected to each other via a wire, and orthodontic correction is achieved by external force of the wire. In addition to the above-described orthodontic device, treatment using a transparent orthodontic device tends to increase.

Korean Utility Model Registration No. 20-0172086 discloses a lingual bracket for orthodontic treatment, and this is a known bracket in which sizes of an occlusal slot and a horizontal slot are different from each other, and central cross-sectional portions of an arch wire coupled are alternately formed with respect to each other, wherein the occlusal slot and the horizontal slot of the bracket for correction of teeth such as premolar, molar and anterior teeth are aligned on an occlusal surface so that arch wires of the same size can be used together.

In particular, to attach the bracket to each tooth surface, teeth on a labial side are cleaned and then dried, and then a portion of each tooth to which the bracket is attached is subjected to acid treatment using an acid etchant to form a fine uneven surface, followed by cleaning, thereby obtaining the tooth surface with fine artificially-formed irregularities. After drying once again, a bonding agent is first applied to the tooth surface, and then a certain amount of resin is mounted on a portion of the tooth surface to which the bracket is attached and is also applied to a basal portion of the tooth surface contacting the bracket. In this case, when the accurate portion of the tooth surface is pressed, extra resin escapes therefrom, the tooth surface is closely welded to a lower surface of the bracket, and, when the resin is photocured, the bracket is attached to the tooth surface. Thereafter, the extra cured resin is cleanly removed using an instrument.

### DISCLOSURE

### Technical Problem

An existing orthodontic method of attaching a bracket to each of a plurality of teeth is disadvantageous in that a metallic bracket is aesthetically deteriorated during orthodontic treatment compared to a bracket of a transparent resin or a resin having the same color as that of teeth, transition portions between the resin and the tooth surface and between the resin and the bracket are rough and at right angles so that food residues on the teeth cannot be satisfactorily removed by brushing, resulting in a high cavity rate during or after tooth correction.

In addition, a wire is present in a horizontal slot in a transparent bracket, and the wires are ligatured together by a transparent elastic rubber ring or a ligature wire. Portions having a pale yellow color therearound are cured resin residues and food residues remaining for a long time on teeth. These portions are likely to develop into cavities after a long period of time.

Therefore, there is a need to address these problems. The present invention has been made in view of the above problems, and it is one object of the present invention to provide an orthodontic device that is fabricated by preparing a thin circular cylindrical form in a solidified state at room temperature using a substance capable of being dissolved by saliva secreted in the mouth or food, beverage, and the like to correspond to an exterior size of each of a plurality of teeth, wherein the cylindrical-type solidified product is adhered to each tooth to be corrected, using a resin, which is a tooth surface adhesive, to correspond to each tooth surface, and then dissolved after a certain period of time to form an empty space therein, i.e., a resin mini-tube form, through which an arch wire can be easily inserted, that significantly reduces the occurrence of cavities by using the resin, and that reduces orthodontic treatment costs.

It is another object of the present invention to provide an orthodontic device that enables complete tooth correction for deciduous dentition before adult orthodontic treatment by applying a thin wire in a case in which an adult bracket cannot be attached to a tooth, simply treats movement of teeth, separation between teeth, and the like that occur due to periodontal diseases, minimizes friction between an arch wire and a resin bracket even in orthodontic treatment for permanent teeth, causes no sense of a foreign object in the mouth due to a small volume thereof, and reduces orthodontic treatment time.

### Technical Solution

In accordance with one aspect of the present invention, provided is an orthodontic device including: a unit wire positioned on a labial or lingual side of a tooth of an upper teeth group or a corrected tooth of a lower teeth group; an adhesive adhered to a corresponding tooth while covering the unit wire, and fixed by curing; a soluble substance formed at the unit wire to prevent the unit wire from being adhered to the adhesive and dissolved afterwards; and an arch wire inserted into the adhesive from which the unit wire containing the soluble substance in a dissolved state has been removed and moving in an axial direction to move the entire teeth.

In accordance with another aspect of the present invention, provided is an orthodontic device including: a soluble substance comprising a soluble material and being of a solid type; an adhesive positioned on a labial or lingual side of a tooth of an upper teeth group or a corrected tooth of a lower teeth group while covering the soluble substance, adhered to a corresponding tooth, and fixed by curing; and an arch wire inserted into the adhesive in which the soluble substance is in a dissolved state and moving in an axial direction.

The adhesive may have the same color and shape as those of teeth.

The soluble substance may include diameter-enlarged portions at edges thereof so that the arch wire is easily inserted into edges of the adhesive.

The soluble substance may be provided with flanges at circumferential surfaces thereof.

### Advantageous Effects

As described above, an orthodontic device according to the present invention is fabricated by preparing a thin circular cylindrical form in a solidified state at room temperature using a substance capable of being dissolved by saliva secreted in the mouth or food, beverage, and the like to correspond to an exterior size of each of a plurality of teeth, wherein the cylindrical-type solidified product is adhered to each tooth to be corrected, using a resin, which is a tooth surface adhesive, to correspond to each tooth surface, and then dissolved after a certain period of time to form an empty space therein, i.e., a resin mini-tube form, through which an arch wire can be easily inserted, significantly reduces the occurrence of cavities by using the resin, and reduces tooth correction costs.

In addition, in a case in which an adult bracket cannot be attached to a tooth, a thin wire can be applied, and thus complete tooth correction can be performed on deciduous dentition before adult orthodontic treatment, movement of teeth, separation between teeth, and the like that occur due to periodontal diseases can be simply treated, friction between an arch wire and a resin bracket, used for tooth correction, can be minimized even in orthodontic treatment for permanent teeth, the orthodontic device causes no sense of a foreign object in the mouth due to a small volume thereof, and orthodontic treatment time can be reduced, and, accordingly, adult orthodontic treatment can be simply performed.

### DESCRIPTION OF DRAWINGS

FIG. 1 is a perspective view illustrating a state in which an orthodontic device according to a first embodiment of the present invention is installed in a group of upper and lower teeth.

FIG. 2 is a cross-sectional view illustrating a state in which an arch wire of the orthodontic device according to a first embodiment of the present invention is inserted into an adhesive.

FIG. 3 is a perspective view illustrating a state in which the arch wire of the orthodontic device according to a first embodiment of the present invention is inserted into the adhesive.

FIG. 4 is a cross-sectional view illustrating a state in which an arch wire of an orthodontic device according to a second embodiment of the present invention is inserted into an adhesive.

FIG. 5 is a cross-sectional view illustrating a state in which an arch wire of an orthodontic device according to a third embodiment of the present invention is inserted into an adhesive.

### BEST MODE

Hereinafter, embodiments of an orthodontic device according to the present invention will be described with reference to the accompanying drawings. In the drawings, the thicknesses of illustrated lines or the sizes of elements may be exaggerated for clarity and convenience of explanation. In addition, terms described below are defined in consideration of functions of the present invention and may vary according to intents, precedents, or the like of users or operators. Thus, these terms must be defined based on the contents of the present specification.

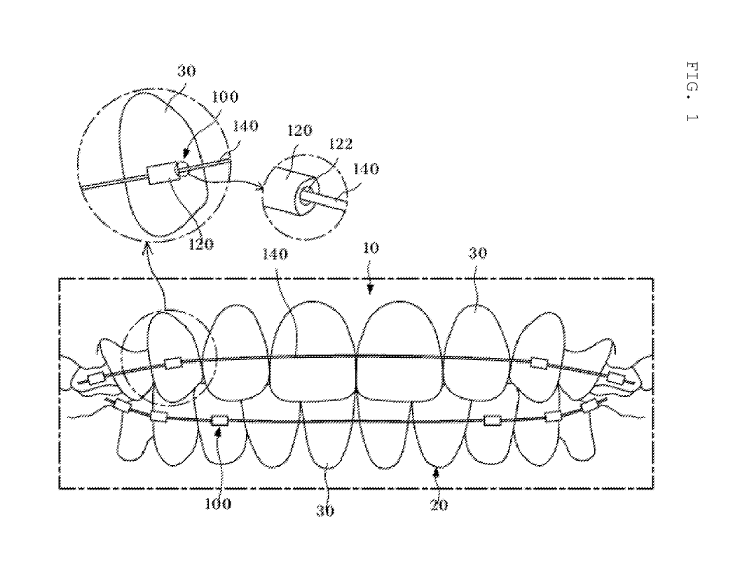

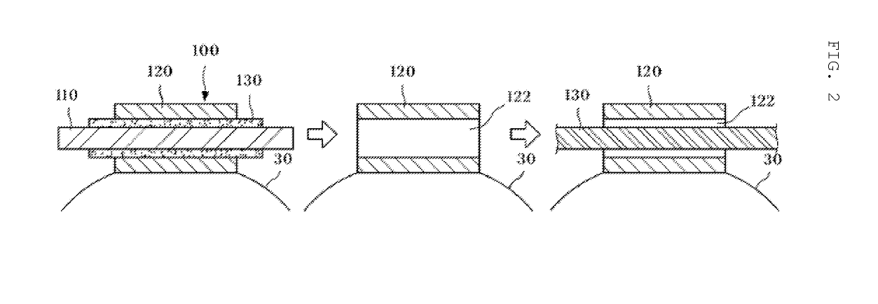

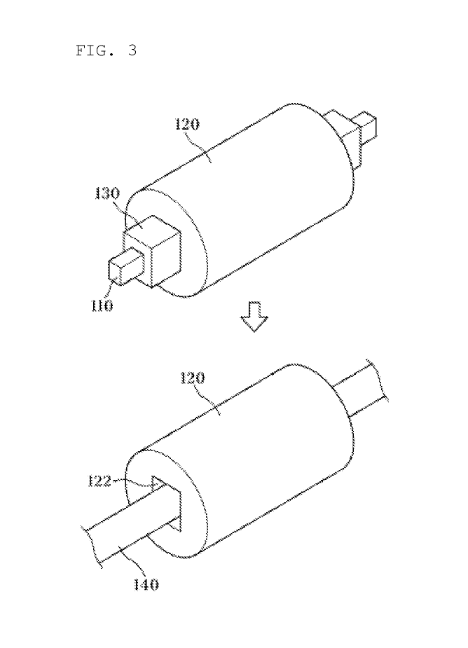

FIG. 1 is a perspective view illustrating a state in which an orthodontic device according to a first embodiment of the present invention is installed in a group of upper and lower teeth. FIG. 2 is a cross-sectional view illustrating a state in which an arch wire of the orthodontic device according to a first embodiment of the present invention is inserted into an adhesive. FIG. 3 is a perspective view illustrating a state in which the arch wire of the orthodontic device according to a first embodiment of the present invention is inserted into the adhesive.

Referring to FIGS. 1 to 3, the orthodontic device 100 according to a first embodiment of the present invention includes a unit wire 110, an adhesive 120, a soluble substance 130, and an arch wire 140.

The unit wire 110 is configured to correspond to a tooth 30 to be corrected from among teeth 30 of an upper teeth group 10 or a lower teeth group 20. In particular, the unit wire 110 may be positioned on a labial or lingual side of the tooth 30.

In this case, the upper teeth group 10 refers to a group of a plurality of teeth 30 positioned in the upper jaw. In addition, the lower teeth group 20 refers to a group of a plurality of teeth 30 positioned in the lower jaw.

In addition, the unit wire 110 may be a wire obtained by cutting the arch wire 140 described below to a unit length. Thus, the unit wire 110 does not need to be separately fabricated, resulting in reduced manufacturing costs of the orthodontic device 100.

In this case, the unit wire 110 may have one of various cross-sectional shapes, such as a circular cross-sectional shape, a polygonal cross-sectional shape, or the like.

In particular, lingual or labial surface areas of the teeth 30 may be different from each other. Thus, the unit wires 110 may have different lengths. In this case, unit wires 110 applied to the same teeth 30 have the same length.

In addition, the adhesive 120 covers the unit wire 110 and is cured and fixed after being attached to the corresponding tooth 30.

In other words, the adhesive 120 is attached to a tooth surface of the tooth 10 to be corrected while covering the unit wire 110. In this case, the adhesive 120 is in a gel state, and thus is cured after being attached to the tooth surface of the tooth 30 to be corrected while covering the unit wire 110.

In particular, the adhesive 120 is attached to a minimum area of the tooth surface of the tooth 30, and a transition portion between the adhesive 120 and the tooth surface maintains a smooth curved surface, and thus food is unlikely to stick thereto, and, accordingly, the teeth 30 may be protected. In addition, the tooth surface of the tooth 30 is not polished to a large area, and thus a cavity does not occur at a portion thereof to which the adhesive 120 is attached.

In addition, to impart an aesthetically pleasing appearance, the adhesive 120 may have the same color and shape as those of the teeth 30. In addition, the adhesive 120 may be formed of a material that does not cause displeasure when brought into contact with the gums and is harmless, such as a resin, or the like.

Meanwhile, the soluble substance 130 is positioned at the unit wire 110 to prevent the unit wire 110 from being attached to the adhesive 120. In particular, the soluble substance 130 may be applied to a surface of the unit wire 110. In this case, the soluble substance 130 refers to components dissolved by saliva in the mouth, or the like, and is cured after being applied to the unit wire 110.

In other words, the entire surface of the unit wire 110 is coated with the soluble substance 130. In addition, the adhesive 120 covers the coated unit wire 110 and then is attached to a tooth surface.

In particular, the soluble substance 130 may be a harmless substance dissolved by a specific component such as saliva, or the like over a certain time period. That is, the soluble substance 130 may be a harmless component or a combination of harmless components.

In this case, the soluble substance 130 is naturally dissolved by saliva, or the like, and thus the adhesive 120 has a space 122 with openings at opposite sides thereof.

Meanwhile, the arch wire 140 is formed in a corrected teeth arrangement shape of the teeth 30 of the upper teeth group 10 or the teeth 30 of the lower teeth group 20 and is positioned on a labial or lingual side of the teeth 30.

In this case, the arch wire 140 has a length corresponding to a total teeth arrangement distance of the upper teeth group 10 or the lower teeth group 20. Thus, after the unit wires 110 in a state in which the soluble substances 130 are dissolved are easily removed from the respective adhesives 120, the arch wire 140 is inserted into the spaces 122 of the adhesives 120. In addition, the arch wire 140 moves in an axial direction to move the entire teeth.

In other words, the arch wire 140 is hung over all of the teeth 30 with the same teeth arrangement needed for orthodontic treatment. The type and diameter or thickness of a metal of the arch wire 140 may vary according to a degree of orthodontic treatment of the teeth 30, i.e., movement direction and amount of teeth. The arch wire 140 imparts lateral pressure or distortion force to the corresponding teeth 30 for orthodontic treatment, and thus corrects the teeth arrangement of the corresponding teeth 30. The arch wire 140 may be made of various materials, e.g., a shape memory alloy. In this case, the arch wire 140 has the same cross-sectional shape as that of the unit wire 110.

In particular, the arch wire 140 according to the present invention is applicable in a state in which an arbitrary tooth 30 is extracted or not extracted.

In addition, the adhesive 120 is configured to correspond to the tooth 30 to be corrected, and a contact area between the adhesive 120 and the tooth surface may be increased to move the entire teeth, thereby reducing a correction period of the teeth 30.

In addition, when teeth arrangement is not uniform, the adhesives 120 may have different thicknesses and distances between the adhesives 120 and the corresponding tooth surfaces may be adjusted so that the arch wire 140 can have a uniform curvature or a set curvature.

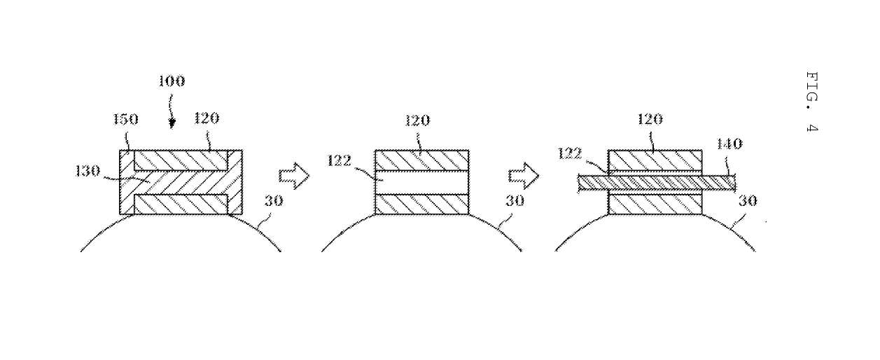

FIG. 4 is a cross-sectional view illustrating a state in which an arch wire of an orthodontic device according to a second embodiment of the present invention is inserted into an adhesive.

Referring to FIG. 4, the orthodontic device 100 according to a second embodiment of the present invention includes a soluble substance 130, an adhesive 120, and an arch wire 140.

Similar to the first embodiment, the soluble substance 130 is made of a soluble and harmless material.

In particular, the soluble substance 130 is of a solid type. In particular, the soluble substance 130 may be fabricated into a bar shape. In this case, the bar-shaped soluble substance 130 may have a circular or polygonal cross-sectional shape.

In other words, the solid bar-shaped soluble substance 130 is dissolved by a specific component such as saliva or the like after a certain period of time and is harmless. That is, the soluble substance 130 is a harmless component or a combination of harmless components.

In this case, the soluble substance 130 is naturally dissolved by saliva, or the like, and thus the adhesive 120 has a space 122 with openings at opposite sides thereof. The arch wire 140 is easily inserted into the adhesive 120 via the space 122.

In addition, the adhesive 120 is positioned on a labial or lingual side of the tooth 30 of the upper teeth group 10 or the corrected tooth 30 of the lower teeth group 20 while covering the soluble substance 130, adhered to the corresponding tooth 30, and then cured and fixed thereto.

The adhesive 120 is the same as that used in the first embodiment.

In addition, the arch wire 140 is inserted into the adhesive 120 in which the soluble substance 130 is in a dissolved state. In addition, the arch wire 140 axially moves while being inserted into the adhesive 120 so that the entire teeth move.

Meanwhile, the solid soluble substance 130 may be provided, at opposite edge circumferential surfaces thereof, with flanges 150 to prevent the adhesive 120 attached to the edge circumferential surfaces from escaping in an axial direction.

In this case, the flanges 150 may have various shapes, and a height thereof may vary according to teeth arrangement. In addition, the flanges 150 as well as the soluble substance 130 are dissolved by saliva or the like after a certain period of time.

Reference numbers having not been described in the present embodiment are the same as those described above.

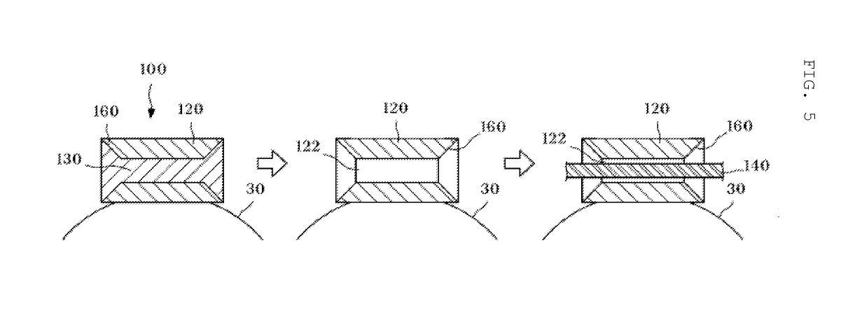

FIG. 5 is a cross-sectional view illustrating a state in which an arch wire of an orthodontic device according to a third embodiment of the present invention is inserted into an adhesive.

Referring to FIG. 5, the orthodontic device 100 according to a third embodiment of the present invention includes a soluble substance 130, an adhesive 120, and an arch wire 140.

In this case, the soluble substance 130, the adhesive 120, and the arch wire 140 are the same as those described above.

In addition, the solid soluble substance 130 is provided with diameter-enlarged portions 160 at opposite sides thereof. Accordingly, the adhesive 120 applied to a circumferential surface of the soluble substance 130 forms the diameter-enlarged portions 160 at opposite sides thereof after the soluble substance 130 is dissolved. The diameter-enlarged portions 160 formed at opposite edges of the adhesive 120 guide the arch wire 140 to be easily inserted into the edges of the adhesive 120.

Reference numerals having not been described in the present embodiment are the same as those described above.

While embodiments of the present invention have been described with reference to the accompanying drawings, these are provided for illustrative purposes only. In addition, it will be understood by one of ordinary skill in the art to which the present invention pertains that various changes and equivalents thereto can be made. Thus, the true spirit and scope of the present invention should be defined by the following claims.

1. An orthodontic device comprising:
a unit wire positioned on a labial or lingual side of a tooth of an upper teeth group or a corrected tooth of a lower teeth group;
an adhesive adhered to a corresponding tooth while covering the unit wire, and fixed by curing;
a soluble substance formed at the unit wire to prevent the unit wire from being adhered to the adhesive and dissolved afterwards; and
an arch wire inserted into the adhesive from which the unit wire containing the soluble substance in a dissolved state has been removed and moving in an axial direction to move entire teeth.

2. An orthodontic device comprising:
a soluble substance containing a soluble material and being of a solid type;
an adhesive positioned on a labial or lingual side of a tooth of an upper teeth group or a corrected tooth of a lower teeth group while covering the soluble substance, adhered to a corresponding tooth, and fixed by curing; and
an arch wire inserted into the adhesive in which the soluble substance is in a dissolved state and moving in an axial direction.

3. The orthodontic device according to claim 1 or 2, wherein the adhesive has the same color and shape as those of teeth.

4. The orthodontic device according to claim 2, wherein the soluble substance has diameter-enlarged portions at edges thereof so that the arch wire is easily inserted into edges of the adhesive.

5. The orthodontic device according to claim 2 or 4, wherein the soluble substance is provided with flanges at circumferential surfaces thereof.
